(19) United States
(12) Patent Application Publication
(10) Pub. No.: US 2025/0080653 A1
(43) Pub. Date: Mar. 6, 2025

(54) METHOD AND APPARATUS FOR CREATING A DATABASE OF CONTACT CENTER RESPONSE RECORDS

(71) Applicant: Talkdesk, Inc., San Francisco, CA (US)

(72) Inventors: Jiali Xiang, Wuhan (CN); Marta Sofia da Silva Pereira, Porto (PT); João Ribeiro Marques, Lisboa (PT); Vitor Alves Cardoso, Coimbra (PT); Dina Raquel Dias Barbosa, Lisboa (PT); Haili Zhen, Wuhan (CN); Isa Maria da Silva Costa, Lisboa (PT); Alex Harvey Wake, Shrewsbury (GB)

(21) Appl. No.: 18/238,926

(22) Filed: Aug. 28, 2023

(51) Int. Cl. H04M 3/51

(52) U.S. Cl. CPC H04M 3/5175; H04M 2203/558

(57) ABSTRACT

Methods and systems for creating and using a knowledge base in a contact center. Templates, including responses to specific issues, are made available to agents in dynamic manner to allow agents to be more efficient while performing their daily job. A centralized database of templates is created in a novel manner to be used for multiple digital channels. The templates can be used and reused by multiple systems such as an agent assistant system or a virtual agent system, providing an integrated and consistent experience for responding to communications in a contact center.

### BACKGROUND

Contact centers, in which incoming communications from inquiring parties (such as customers) are routed to agents, are well known. FIG. 1 is an example system architecture of a cloud-based contact center platform. Customers 110, i.e., parties originating incoming communications to a contact center, interact with the contact center 150 using voice, email, text, web, chat and other channels to communicate with the agents 120 through a network 130. Note that the term “customer”, as used herein, refers to a party contacting the contact center for service, information, or the like and includes actual purchasers, potential purchasers, and other parties.

Contact center 150 includes computing modules for the routing communications from customers 110 to agents 120 for the contact center 150. These modules are referred to herein as the contact routing system 140. The contact routing system 140 could be any of a contact center as a service (CCaaS) system, an automated call distributor (ACD) system, or a case system, for example.

Agents 120 may be remote from the contact center 150 and handle communications (also referred to as “conversations” herein) with customers 110 on behalf of an enterprise or other entity. Agents 120 may utilize devices, such as work stations, desktop computers, laptops, telephones, a mobile smartphone and/or a tablet. Similarly, customers 110 may communicate using a plurality of devices, including but not limited to, a telephone, a mobile smartphone, a tablet, a laptop, a desktop computer, or other devices. For example, telephone communication may traverse networks such as a public switched telephone networks (PSTN), Voice over Internet Protocol (VOIP) telephony (via the Internet), a Wide Area Network (WAN) or a Large Area Network (LAN). The network types are provided by way of example and are not intended to limit types of networks used for communications.

Agents 120 may be assigned to one or more “queues” representing communication categories and/or agent skill levels. Agents 120 assigned to a queue may handle communications that are placed in the queue by the contact routing system 140. For example, there may be queues associated with a language capability of the agent (e.g., English or Chinese), topic (e.g., technical support or billing), or a particular country of origin. When a communication is received by the contact routing system 140, the communication may be placed in a relevant queue, and one of agents 120 associated with the relevant queue may handle the communication. The communications may be assigned to an agent (“push communications”) or selected by the agent out of the queue (“pull communications”).

Agents 120 may be further organized into one or more teams based on a variety of factors including skills, location, experience, assigned queues, associated or assigned customers 110, and shift. The purpose of communication routing system 140 is to route communications to an agent who is likely to be able to handle the communication in an efficient manner and to the satisfaction of the customer who originated the communication.

Also It is known to use pre-defined messages, i.e., templates, when replying to customers to increase the agent's efficiency and present harmonized responses that are not dependent on the capabilities of the agent. Instead of writing all the messages from scratch, agents can use a library of predefined responses, stored in a knowledge base, to assist them while composing the answers for the communications. To be effective, template responses should be aligned with the company speech and the information must be as updated and accurate as possible, to make sure that the contact center is sharing the correct information with various systems.

“Virtual Agent” systems have been developed recently to provide fully automated answers, through messaging channels for example, to customers without the need for intervention by a human agent. Information changes rapidly and it is very cumbersome to get the information updated consistently when the same content is used for several different purposes in several different applications. If a customer changes the information to be shared with the agent, they need to get this information updated in several different systems, such as in virtual agent systems and live agent assist systems, in order to avoid inconsistency of data.

### SUMMARY OF THE INVENTION

The disclosed implementations make templates available to agents in dynamic manner to allow agents to be more efficient while performing their daily job. A centralized database of templates is created in a novel manner to be used for multiple digital channels. The templates can be used and reused by multiple systems such as an agent assistant system or a virtual agent system, providing an integrated and consistent experience for responding to communications in a contact center. Templates can be initially created by content creators or administrators within a contact center system. These templates serve as pre-defined messages or responses for agents to use during customer interactions. During template creation, tags and metadata can be assigned to the templates to identify the intent and purpose of the template content. The tagging process ensures that templates are properly categorized and can be easily retrieved based on specific criteria. A guide API plays a role in integrating the template database with the contact center system and applications. The guide API enables seamless communication and synchronization between the template database and various components, such as an agent assist component and a virtual agent component. Once the templates are created, tagged, and stored in the database, the templates can be used by both an agent assist component and a virtual agent component. These AI-driven features utilize the tags and metadata to propose relevant template answers or responses to agents during customer interactions. This proactively assists agents by suggesting the most suitable template based on the context and intent of the conversation. As new customer interactions occur, feedback is collected from agents and customers. This feedback is then used to refine and improve the existing templates or create new ones. The database is updated accordingly to reflect these changes, ensuring that it remains up-to-date and aligned with evolving customer needs.

A first aspect is a method for creating a database of contact center template response records which can be used to provide contact center agents with responses to communications from customers, the method comprising: creating at least one response template data structure including at least one potential response to a customer communication; for each of the at least one response template data structure: (1) associating metadata with each of the at least one response template data structures, the metadata including one or more channels of communication relating to the at least one response template data structure, at least one keyword from the response of the at least one response template data structure, and a template group indicator; and (2) associating an intent tag with each of the at least one response template data structures, the intent tag being determined by an AI intent engine analyzing a specific communication between a contact center agent and a customer for which the contact center agent used the potential response of the at least one response template data structures as a response to the specific communication; and storing each of the at least one response template data structures with corresponding metadata and intent tags in a database of a knowledge management system that is used to provide contact center agents with responses to communications from customers.

A second aspect of the invention is a computer system for creating a database of contact center template response records which can be used to provide contact center agents with responses to communications from customers, the method comprises computer processors executing instructions that are stored in memory to accomplish a method of: creating at least one response template data structure including at least one potential response to a customer communication; for each of the at least one response template data structure: (1) associating metadata with each of the at least one response template data structures, the metadata including one or more channels of communication relating to the at least one response template data structure, at least one keyword from the response of the at least one response template data structure, and a template group indicator; and (2) associating an intent tag with each of the at least one response template data structures, the intent tag being determined by an AI intent engine analyzing a specific communication between a contact center agent and a customer for which the contact center agent used the potential response of the at least one response template data structures as a response to the specific communication; and storing each of the at least one response template data structures with corresponding metadata and intent tags in a database of a knowledge management system that is used to provide contact center agents with responses to communications from customers.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the appended drawings various illustrative embodiments. It should be understood, however, that the invention is not limited to the precise arrangements and instrumentalities shown. In the drawings:

FIG. 1 is a block diagram of a contact center platform architecture.

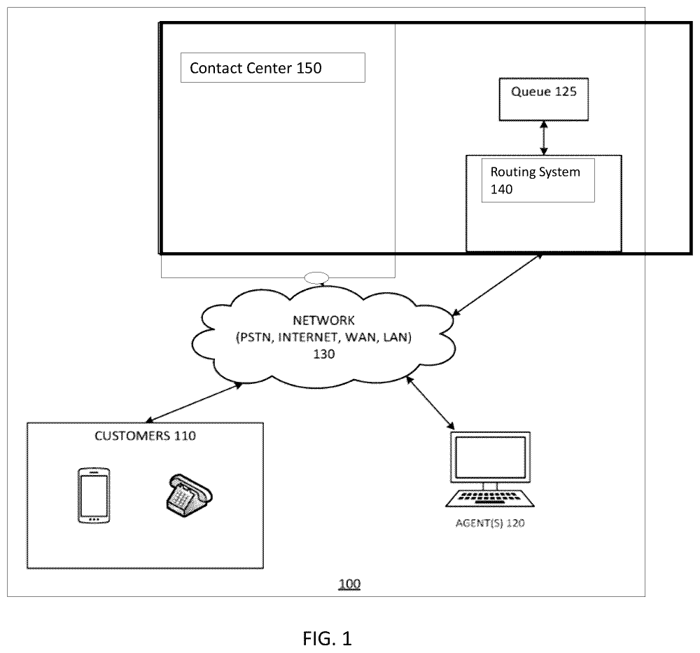

FIG. 2 is a flowchart of template workflows in accordance with disclosed implementations.

FIG. 3 is a flowchart of a process for creating database records in accordance with disclosed implementations.

FIG. 4 is a computing system for creating database records in accordance with disclosed implementations.

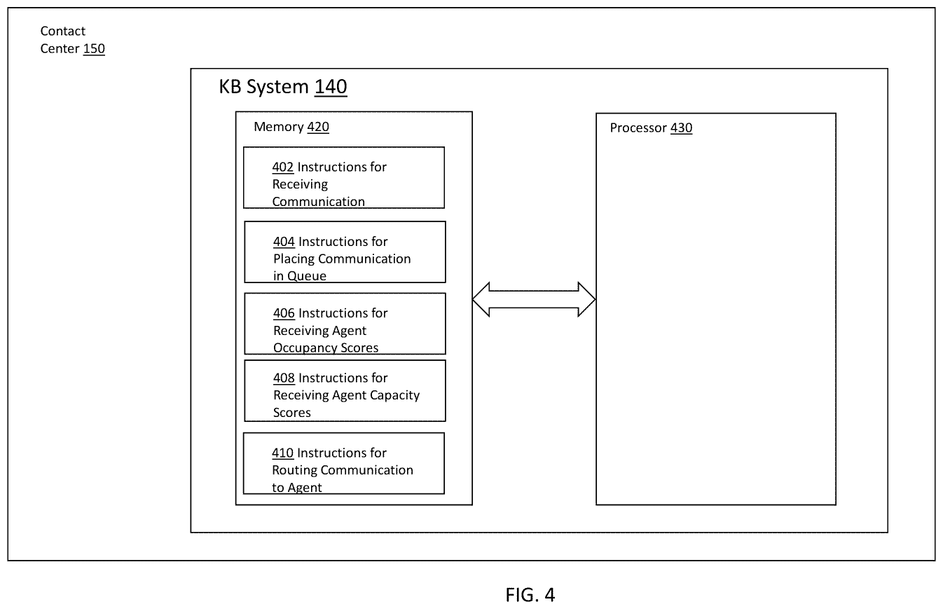

FIG. 5 illustrates an example of a user interface in accordance with disclosed implementations.

FIG. 6 illustrates and example of a user interface in accordance with disclosed implementations.

FIG. 7 illustrates and example of a user interface in accordance with disclosed implementations.

FIG. 8 illustrates an example of a user interface in accordance with disclosed

FIG. 9 illustrates an example of a user interface in accordance with disclosed implementations.

### DETAILED DESCRIPTION

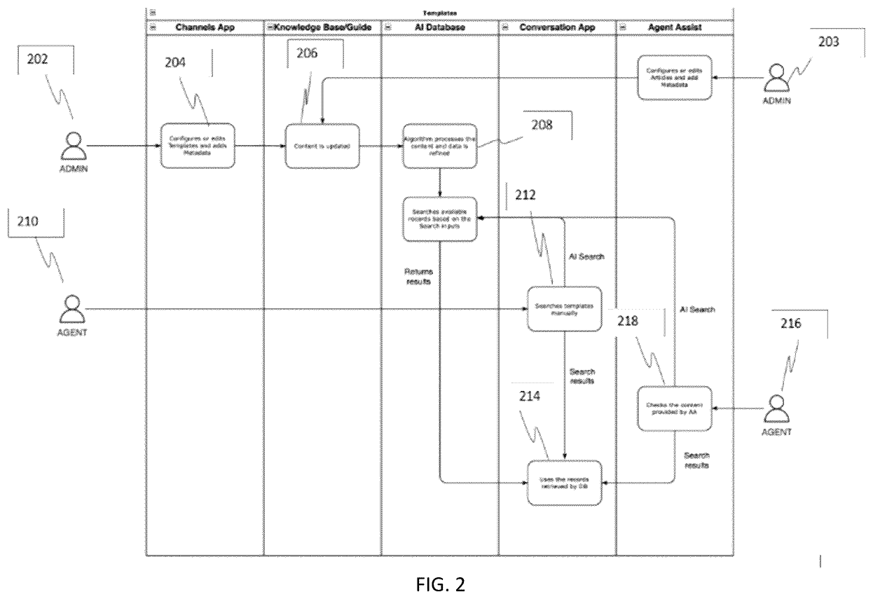

Disclosed implementations create and enhance templates as records in a database using tags that identify the intent of the content. The tags can be gathered from various remote systems. These tags are then used in live agent assist systems and/or in virtual agent systems. The templates can be used to propose content to live agents (thereby proactively assisting the contact center agent) and can be used as automated responses by virtual agents. Interactions by the live agents are used to enhance the tags and update the template records. FIG. 2 illustrates a workflow implementing templates in accordance with disclosed implementations. FIG. 2 illustrates three separate but related The first workflow is initiated by an administrator, at 202, to create a database record. At 204, an administrator uses an application having a user interface to configure or edit a template and/or add metadata to the template in the manner described in detail below. At 206, a database template record, including the response and the metadata is created and/or updated. At 208, the record is supplied to an artificial intelligence (AI) model and the AI model analyzes the intent and/or sentiment of the communications for which the template is used (in the workflows described below) and the AI database is updated based on the record to associate new content with the specific intent. Similarly, the administrator can configure or edit content records, such as relevant articles in the database at 203. The second workflow is initiated, at 210, by a live agent, during a communication for example, to retrieve a response from the database based on the communication that is being handled by the agent. At 212, an agent searches the database based using a query based on a current communication. At 214, the agent receives templates and/or other content (such as relevant articles) as search results and uses the search results to address an issue raised in the communication.

Stated differently, the query is used to locate one or more templates or other content records having a response or other information relevant to the communication and the response or other information is returned to the live agent to assist the live agent in addressing an issue raised in the communication being handled by the live agent. For example, the query can include keywords and topics from the conversation between the live agent and a customer. The third workflow is initiated at 216 by an agent who, for example, is not currently on a communication. At 218, this agent searches that database for articles and templates. In each instance, templates and other content, such as articles are enhanced by the AI algorithm and stored in the database.

The metadata that is stored in the record in association with the response language can include a channel indicator (channels can include voice, text, IM, chat . . . ), keywords, and collection information (such as links to related records). Further, the AI engine is used to determine the sentiment and/or intent of a communication and sentiment and/or intent data is stored as record metadata. This allows an AI engine, such as an AI engine used for a virtual assistant, to leverage a Knowledge Management (KM) database that is created for live agent assist applications, thus enhancing the data records in the KM database and allowing a virtual assistant AI engine to leverage the KM database. Stated differently, templates are created using tags that help identify the intent of the content. These tags are then used in live agent assist systems and/or virtual agent systems when proposing the content to the agent, pro-actively, assisting the contact center agent. All of these operations can be supported by an API.

Intent metadata added to the KM database can be indexed by the AI Search which adds AI capability to templates. AI search can leverage APIs that are used not just as a federated search over different knowledge bases (internal like Knowledge Management or external imported like Confluence, Zendesk, or even from external databases) but contains AI capabilities over searching and knowledge context, e.g., a cognitive search. Since the templates are built on top of the KM database suite, templates leverage KM capabilities.

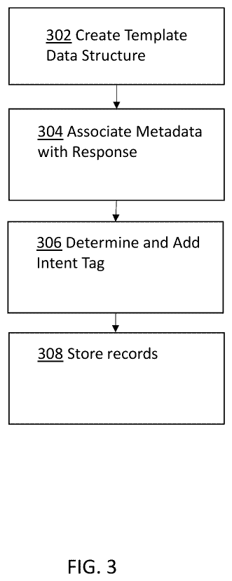

FIG. 3 illustrates a method for creating the database records which can be used to provide contact center agents with responses to communications from customers. At step 302, at least one response template data structure, is created. The data structure includes at least one potential response to a customer communication. Steps 304 and 306 are then accomplished for each template data structure. At step 304, metadata is associated with the response in the template at which, when executed by processor 460 can accomplish the method of FIG. 3. Each code portion includes instructions which, when executed by processor 430 comprise a module that accomplishes a step of the method of FIG. 3. The code portions include code portion 402 corresponding to step 302 of FIG. 3, code portion 404 corresponding to step 304 of FIG. 3, code portion 406 corresponding to step 306 of FIG. 3, and code portion 408 corresponding to step 308 of FIG. 3. KB system 140 is illustrated as being part of contact center 150. However, KB system 140 can be separate from contact center 150 and provide a knowledge base for contact center 150 as a service, through a network and appropriate APIs and protocols. Various data from the remote systems of the contact center can be used by KB system 140 to enhance data records.

During a communication, the agent can access the knowledge base of templates by activating a user interface element, such as using a hotkey in an Email editor. When composing the outbound message, and without having the need to go to the templates list, the agent can activate the user interface element and/or enter a keyword and a list of templates associated with that keyword (through tags) will be listed. Since this is a cross-channel feature, only the templates suitable for the channel in context will be presented to the agent.

By activating a user interface element, such as clicking on a “Preview” button, the agent can check the template details and confirm if the template includes information relevant to the communication. Templates can be generic, which means that the same content can be used for different channels. Each template can be associated with one or more channels. An administrator can have the ability to order the templates so that the templates can be presented in a preferred order to the agents (live agent) or customer (virtual agent). The administrator can group templates together to aid in organizing and managing content that should be consistent. Manual tags can be added to templates during creation of management thereof by an administrator. Each template can belong to a collection and each collection can be associated with a specified language. This approach allows the templates to be grouped by the pair collection/language, which will allow administrators to organize the content correctly.

Each template can include a topic and messages/responses for each channel to allow different content to be surfaced for each channel. The agent can use a search interface to search for templates that contain specified keywords, topics, and/or contexts. Multiple templates can be selected by an agent to compose a more complex and complete response. Agents can search and select templates in a first language and the corresponding template responses in a second language can be presented to the customer to effectively provide communication translation. Various metrics can be gathered to more efficiently surface the most relevant template, such as how many times each agent accesses the template and how satisfied customers are with the associated response.

The disclosed implementations are an improvement over conventional systems because they provide:
Centralization and Reusability: By using a centralized Knowledge Management/Guide system, templates are stored in a single location. This centralized approach enables easy access and reuse of templates across multiple contact center applications. This eliminates the need for redundant content creation in different places, ensuring consistency and efficiency.
Consistency and Harmonization: The use of tags and metadata allows for consistent classification and organization of templates, ensuring that the same set of tags can be shared across different applications, databases, and technologies. This harmonization facilitates a standardized communication approach, regardless of the channel or agent handling the interaction.
Proactive Assistance and Efficiency: The integration of agent assist and virtual agent functionalities with the same database provides proactive assistance to agents. The AI-driven capabilities leverage the tags and metadata to suggest the most appropriate templates based on the context and intent of the conversation. This streamlines the agent's workflow, increases efficiency, and improves response accuracy.
Scalability and Agility: This approach offers scalability and agility, allowing for easy updates, additions, and modifications to templates. As customer needs change or new scenarios arise, the content can be adapted and expanded accordingly. This flexibility ensures that the templates remain relevant and effective over time.

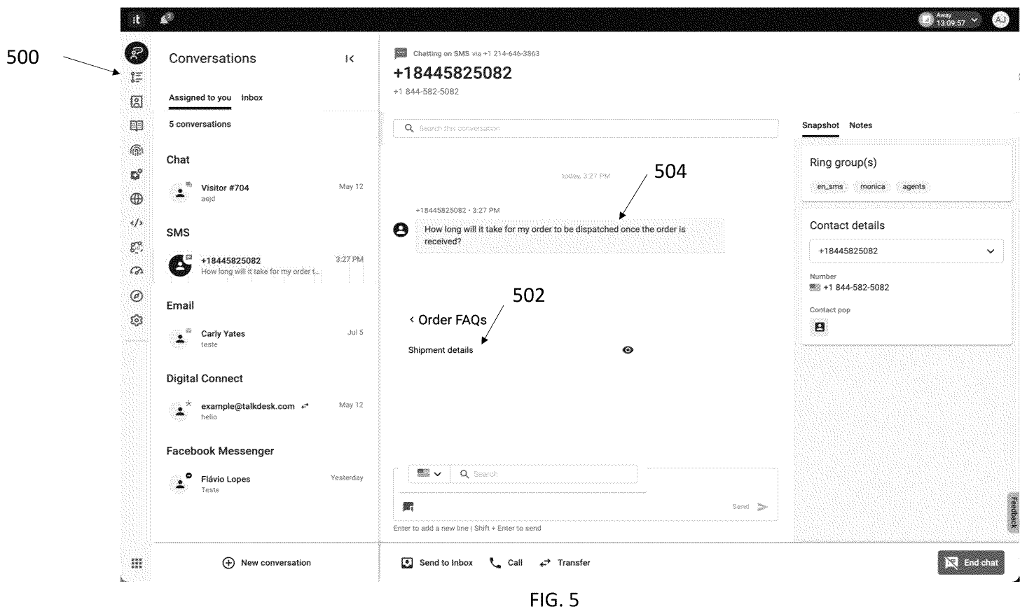

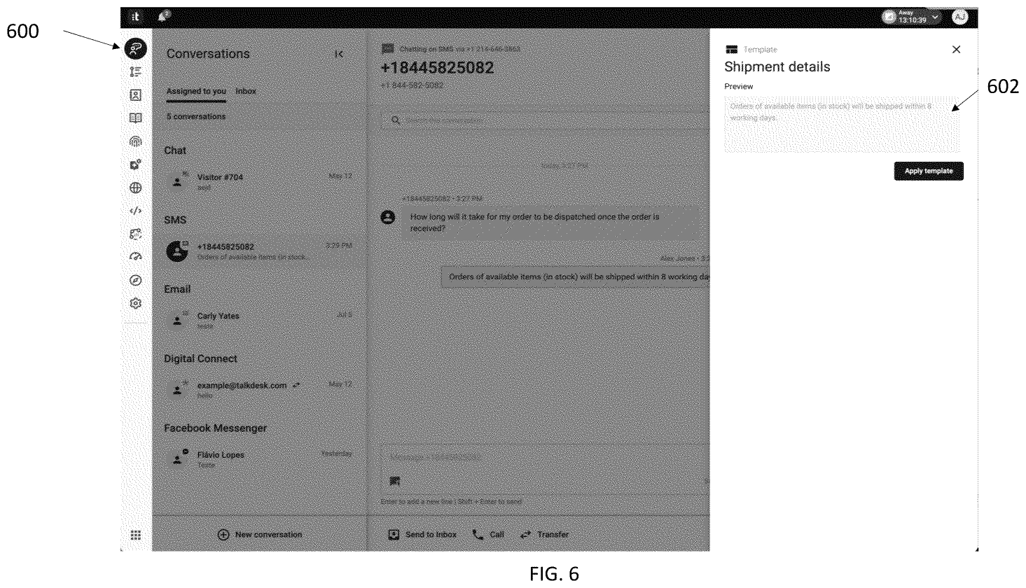

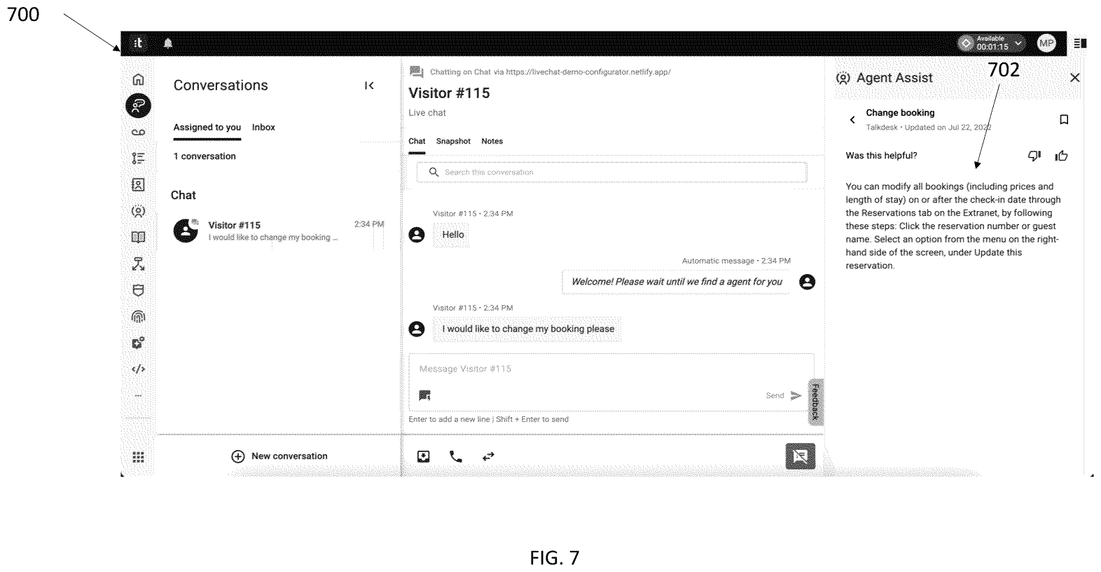

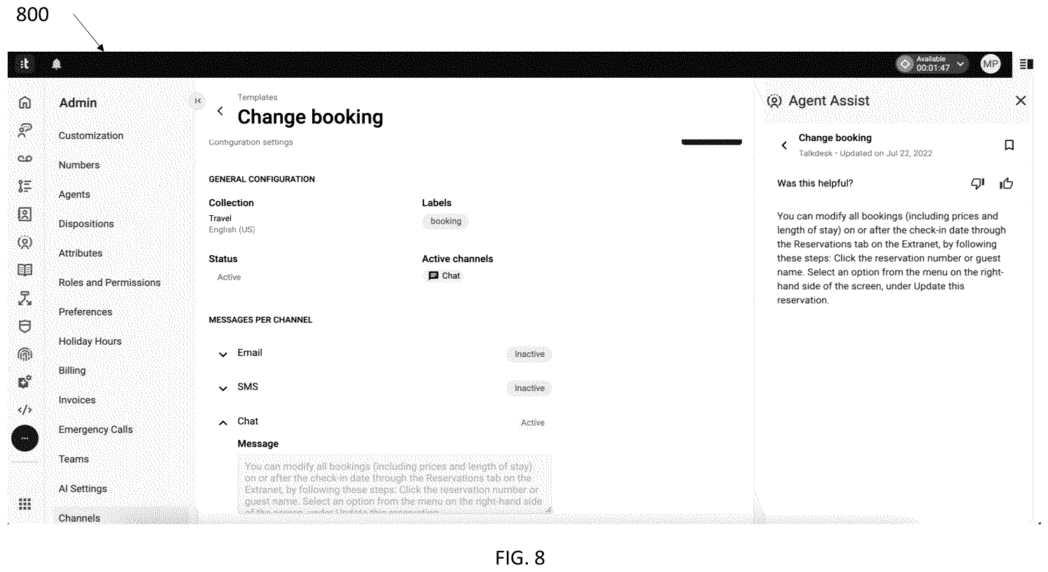

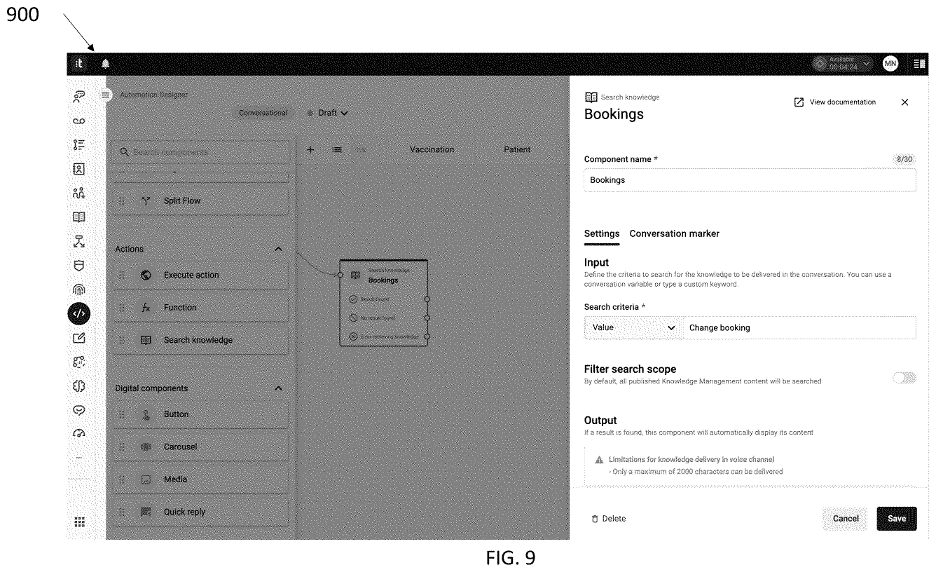

FIG. 5 shows an example of user interface 500 presented to an agent displaying one or more templates 502 to an agent that are relevant to question 504 asked by a customer over an sms channel. FIG. 6 shows an example of user interface 600 showing content details 602 of a template selected by the agent. FIG. 7 shows an example of user interface 700 from which record 702 is retrieved from an agent assist component. FIG. 8 shows an example of user interface 800 showing the back office/admin for templates management alongside the agent assist window wherein the same content is available in both virtual agent templates and agent assist templates. FIG. 9 shows an example of user interface 800 for searching templates in the agent assist mode.

The disclosed implementations can be implemented by various computing devices programmed with software and/or firmware to provide the disclosed functions and modules of executable code implemented by hardware. The software and/or firmware can be stored as executable code on one or more non-transient computer-readable media. The computing devices may be operatively linked via one or more electronic communication links. For example, such electronic communication links may be established, at least in part, via a network such as the Internet and/or other networks.

A given computing device may include one or more processors configured to execute computer program modules. The computer program modules may be configured to enable an expert or user associated with the given computing platform to interface with the system and/or external resources. By way of non-limiting example, the given computing platform may include one or more of a server, a desktop computer, a laptop computer, a handheld computer, a tablet computing platform, a Smartphone, a gaming console, and/or other computing platforms.

The various data and code can be stored in electronic storage devices which may comprise non-transitory storage media that electronically stores information. The electronic storage media of the electronic storage may include one or both of system storage that is provided integrally (i.e., substantially non-removable) with the computing devices and/or removable storage that is removably connectable to the computing devices via, for example, a port (e.g., a USB port, a firewire port, etc.) or a drive (e.g., a disk drive, etc.). The electronic storage may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media.

Processor(s) of the computing devices may be configured to provide information processing capabilities and may include one or more of a digital processor, an analog processor, a digital circuit designed to process information, an analog circuit designed to process information, a state machine, and/or other mechanisms for electronically processing information. As used herein, the term “module” may refer to any component or set of components that perform the functionality attributed to the module. This may include one or more physical processors during execution of processor readable instructions, the processor readable instructions, circuitry, hardware, storage media, or any other components.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed:

1. A method for creating a database of contact center response records which can be used to provide contact center agents with responses to communications from customers, the method comprising:
creating at least one response template data structure including at least one potential response to a customer communication;
for each of the at least one response template data structure:
associating metadata with each of the at least one response template data structures, the metadata including one or more channels of communication relating to the at least one response template data structure, at least one keyword from the response of the at least one response template data structure, and a template group indicator; and
associating an intent tag with each of the at least one response template data structures, the intent tag being determined by an AI intent engine analyzing a specific communication between a contact center agent and a customer for which the contact center agent used the potential response of the at least one response template data structures as a response to the specific communication; and
storing each of the at least one response template data structures with corresponding metadata and intent tags in a database of a knowledge management system that is used to provide contact center agents with responses to communications from customers.

2. The method of claim 1, further comprising:
analyzing the content of a communication between a contact center agent and a customer;
conducting a search of the database with the AI engine to identify at least one response template data structure that corresponds to the communication; and
presenting the potential response of the at least one response template data structure that corresponds to the communication as a response to the communication.

3. The method of claim 1, wherein the step of associating an intent tag is repeated for multiple specific communications between contact center agents and customers.

4. The method of claim 1, wherein the database includes data records from additional resources.

5. The method of claim 4, wherein the additional resources are at least one of a CRM system, an accounting system, and an interaction records system.

6. A distributed computing system for creating a database of contact center response records which can be used to provide contact center agents with responses to communications from customers, the system comprising:
at least one computer hardware processor; and
at least one memory device operatively coupled to the at least one computer hardware processor and storing computer-readable instructions which, when executed by the at least one computer hardware processor, carry out a method of:
creating at least one response template data structure including at least one potential response to a customer communication;
for each of the at least one response template data structure:
associating metadata with each of the at least one response template data structures, the metadata including one or more channels of communication relating to the at least one response template data structure, at least one keyword from the response of the at least one response template data structure, and a template group indicator; and
associating an intent tag with each of the at least one response template data structures, the intent tag being determined by an AI intent engine analyzing a specific communication between a contact center agent and a customer for which the contact center agent used the potential response of the at least one response template data structures as a response to the specific communication; and
storing each of the at least one response template data structures with corresponding metadata and intent tags in a database of a knowledge management system that is used to provide contact center agents with responses to communications from customers.

7. The computing system of claim 6, the method further comprising:
analyzing the content of a communication between a contact center agent and a customer;
conducting a search of the database with the AI engine to identify at least one response template data structure that corresponds to the communication; and
presenting the potential response of the at least one response template data structure that corresponds to the communication as a response to the communication.

8. The computing system of claim 6, wherein the step of associating an intent tag is repeated for multiple specific communications between contact center agents and customers.

9. The computing system of claim 6, wherein the database includes data records from additional resources.

10. The computing system of claim 9, wherein the additional resources are at least one of a CRM system, an accounting system, and an interaction records system.
